(19) United States
(12) Patent Application Publication
(10) Pub. No.: US 2012/0030601 A1
(43) Pub. Date: Feb. 2, 2012

(54) INFORMATION DISPLAY CONTROL APPARATUS, INFORMATION DISPLAY CONTROL METHOD, STORAGE MEDIUM STORING INFORMATION DISPLAY CONTROL PROGRAM

(75) Inventor: Kazuhiro OYOSHI, Tokyo (JP)

(73) Assignee: CANON KABUSHIKI KAISHA, Tokyo (JP)

(21) Appl. No.: 13/195,067

(22) Filed: Aug. 1, 2011

(30) Foreign Application Priority Data
Aug. 2, 2010 (JP) 2010-173627

(51) Int. Cl. G06F 3/048

(52) U.S. Cl. 715/771

(57) ABSTRACT

An information display control apparatus that is capable of displaying a plurality of filenames on a display unit so that the filenames are easily distinguished and original filenames are easily recognized. A first determination unit determines whether the number of characters of each filename is larger than the predetermined number of characters. A second determination unit determines whether the filenames have a common part. A display control unit displays a part of the filename onto the display unit within the predetermined number of characters and to display the full filename by rolling characters when the first determination unit determines that the number of characters of the filename is larger than the predetermined number of characters. The display control unit changes character rolling speed according to a determination result by the second determination unit when the filename is displayed by rolling characters.

### BACKGROUND OF THE INVENTION

1. Field of the Invention

The present invention relates to an information display control apparatus, an information display control method, and a storage medium storing an information display control program, which control information display on a display unit of a printer (an image forming apparatus), for example. Particularly, the present invention relates to the information display control apparatus, the information display control method, and the storage medium storing the information display control program, which displays a filename as the information.

2. Description of the Related Art

In general, a printer that has a function to print image data (an image file) recorded in a storage medium such as a USB memory as an image is provided with a display unit that displays a filename to specify an image file to be printed. When printing an image, a user selects an image file by designating a filename displayed on the display unit. Next, the user designates a required number of copies and prints the image.

Incidentally, many of such printers are equipped with the display units that can display 4 or 5 lines of information rather than conventional units that can display 1 or 2 lines of information in response to user's requests of improvement in operability. For example, an LCD panel of a graphical display system of a dot matrix (about 128×64 dots) is able to display 4 or 5 lines in which 10 through 20 characters are displayed per line.

Accordingly, a long filename cannot be displayed within one line of the display unit. Then, when a part of a filename is not displayed within a line on the display unit, a plurality of files having similar names may not be distinguished by parts of filenames displayed on the display unit.

On the other hand, Japanese Laid-Open Patent Publication (Kokai) No. 2009-163561 (JP 2009-163561A) discloses a technique to generate filenames that are easy to distinguish when displaying a plurality of filenames on the display unit.

The technique of JP 2009-163561A shortens a long filename to generate a new filename that is easily distinguished from other filenames. However, the original filename will be unclear when the filename is shortened.

### SUMMARY OF THE INVENTION

The present invention provides an information display control apparatus, an information display control method, and a storage medium storing an information display control program, which are capable of displaying a plurality of filenames on a display unit so that the filenames are easily distinguished and original filenames are easily recognized.

Accordingly, a first aspect of the present invention provides an information display control apparatus that displays a plurality of filenames onto a display unit for allowing a user to select, comprising a first determination unit configured to determine whether the number of characters of each filename is larger than the predetermined number of characters, a second determination unit configured to compare the filenames to determine whether the filenames have a common part in which common characters continue more than the preset number of characters, and a display control unit configured to display a part of the filename as a partially displayed filename onto the display unit within the predetermined number of characters and to display the full filename onto the display unit by rolling characters when the first determination unit determines that the number of characters of the filename is larger than the predetermined number of characters. The display control unit changes character rolling speed according to a determination result by the second determination unit when the filename is displayed by rolling characters.

Accordingly, a second aspect of the present invention provides an information display control apparatus that displays a plurality of filenames onto a display unit for allowing a user to select, comprising a first determination unit configured to determine whether the number of characters of each filename is larger than the predetermined number of characters, a second determination unit configured to compare the filenames to determine whether the filenames have a common part in which common characters continue more than the preset number of characters, and a display control unit configured to replace at least a part of the common part with a predetermined symbol and to display the replaced filename onto the display unit when the first determination unit determines that the number of characters of the filename is larger than the predetermined number of characters and when the second determination unit determines that there is the common part.

Accordingly, a third aspect of the present invention provides an information display control method for displaying a plurality of filenames onto a display unit for allowing a user to select, comprising a first determination step of determining whether the number of characters of each filename is larger than the predetermined number of characters, a second determination step of comparing the filenames to determine whether the filenames have a common part in which common characters continue more than the preset number of characters, a first display control step of displaying a part of the filename as a partially displayed filename onto the display unit within the predetermined number of characters when it is determined that the number of characters of the filename is larger than the predetermined number of characters in the first determination step, and of displaying the full filename of a selected filename onto the display unit by rolling characters when the partially displayed filename is pointed as the selected filename, and a second display control step of changing character rolling speed according to the determination result in the second determination step when displaying the selected filename by rolling characters.

According to the present invention, since the character rolling speed is changed according to the determination result of whether the similar filenames have a common part, a user can not only distinguish the filenames easily, but also can recognize original filenames easily. As a result, the user can select an image file smoothly.

Further features of the present invention will become apparent from the following description of exemplary embodiments with reference to the attached drawings.

### BRIEF DESCRIPTION OF THE DRAWINGS

FIG. 1 is a functional block diagram schematically showing a configuration of a printer that is provided with an information display control apparatus according to an embodiment of the present invention.

FIG. 2 is a block diagram showing details of the information display control apparatus (a controller unit) of the printer shown in FIG. 1.

FIG. 3 is a block diagram showing details of an operation unit of the printer shown in FIG. 1.

FIG. 4 is a flowchart showing a first example of a file display process in the information display control apparatus shown in FIG. 1.

FIG. 5 is a view showing an example of a filename list displayed on the operation unit shown in FIG. 1.

FIG. 6A is a view showing a screen displayed on the display unit (LCD) of the operation unit shown in FIG. 3 as a result of executing the file display process shown in FIG. 4 for the filename list shown in FIG. 5.

FIG. 6B is a view showing a screen where the selected filename in the screen shown in FIG. 6A is displayed by rolling characters and a character rolling speed becomes slow.

FIG. 6C is a view showing a screen where the selected filename in the screen shown in FIG. 6A is displayed by rolling characters and a character rolling speed becomes fast.

FIG. 7 is a flowchart showing a second example of the file display process in the information display control apparatus shown in FIG. 1.

FIG. 8A is a view showing a screen displayed on the display unit (LCD) of the operation unit shown in FIG. 3 as a result of executing the file display process shown in FIG. 7 for the filename list shown in FIG. 5.

FIG. 8B is a view showing a screen displaying a common part in the selected filename among the filenames in the screen shown in FIG. 8A.

FIG. 8C is a view showing a screen displaying a different part in the selected filename among the filenames in the screen shown in FIG. 8A.

FIG. 9 is a flowchart showing a third example of the file display process in the information display control apparatus shown in FIG. 1.

FIG. 10 is a view showing another example of the filename list displayed on the operation unit shown in FIG. 1.

FIG. 11A is a view showing a screen displayed on the LCD of the shown in FIG. 3 as a result of executing the file display process shown in FIG. 9 for the filename list shown in FIG. 10.

FIG. 11B is a view showing a screen displaying a common part in the selected filename among the filenames in the screen shown in FIG. 11A.

FIG. 11C is a view showing a screen displaying a different part in the selected filename among the filenames in the screen shown in FIG. 11A.

### DESCRIPTION OF THE EMBODIMENTS

Hereafter, embodiments according to the present invention will be described in detail with reference to the drawings.

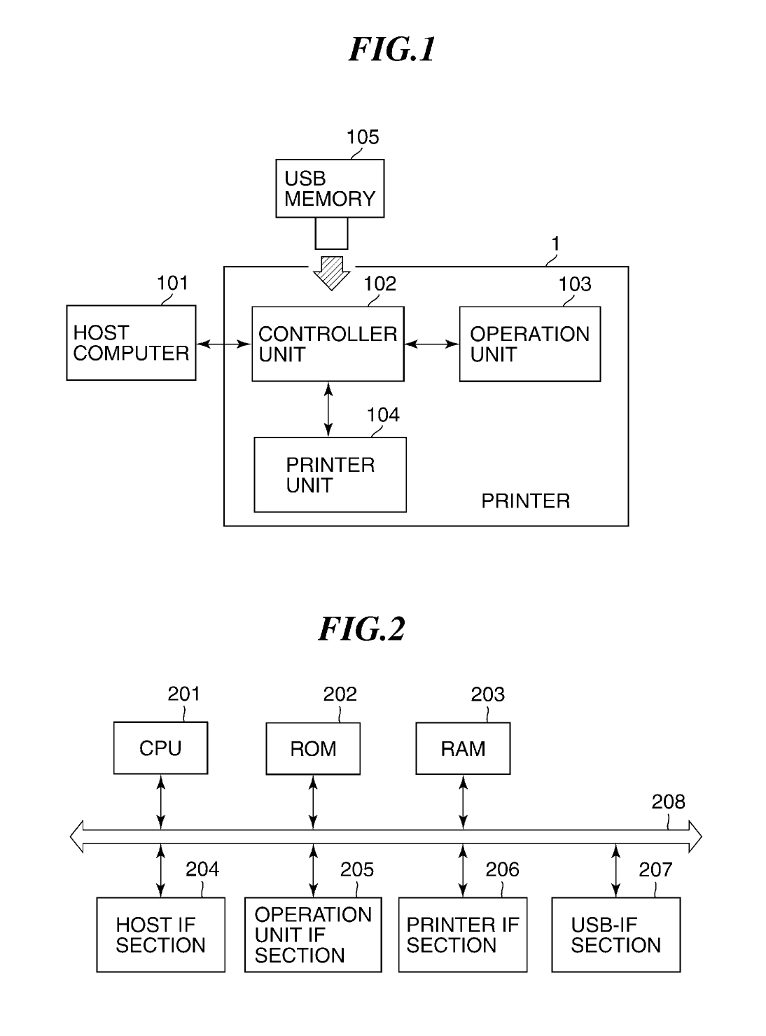

FIG. 1 is a functional block diagram schematically showing a configuration of a printer that is provided with an information display control apparatus according to an embodiment of the present invention.

As shown in FIG. 1, the printer (an image forming apparatus) 1 is provided with a controller unit 102, an operation unit 103, and a printer unit 104 that have a function as the information display control apparatus. The controller unit 102 is connected with the operation unit 103 and the printer unit 104 so as to enable communication. The controller unit 102 controls the operation unit 103 and the printer unit 104. For example, the operation unit 103 is equipped with various keys and a display unit. The controller unit 102 controls the printer unit 104 for printing according to key operations. The controller unit 102 displays a variety of information including status (condition) of the printer unit 104 onto the display unit.

It should be noted that the controller unit 102 first displays a filename given to an image file onto the display unit when displaying the image file recorded in a recording medium etc. to the screen. Then, when the image file to be displayed on the display unit is selected, the controller unit 102 displays the image file corresponding to the filename concerned on the display unit.

In the illustrated example, the controller unit 104 is connected with a host computer 101 via the network etc., and according to the image data sent from the host computer 101, the controller unit 104 controls the printer unit 104, and executes print. A USB memory 105, which is one of the external recording media, is directly connected to the controller unit 102. Then, the controller unit 102 controls the printer unit 104 according to the image data recorded on USB memory 105, and executes print.

When printing, the controller unit 102 converts the image data obtained from the host computer 101 or the USB memory 105 into data that can be processed by the printer unit 104, and transmits the converted data to the printer unit 104. As mentioned above, the control section 102 controls the printer unit 104 according to operation of the operation unit 103, and sends the status of the printer unit 104 to the operation unit 103.

FIG. 2 is a block diagram showing details of the controller unit 102 shown in FIG. 1.

As shown in FIG. 2, the controller unit 102 has a CPU 201, a ROM 202, a RAM 203, a host interface (IF) unit 204, an operation unit IF section 205, a printer IF section 206, and a USB-IF section 207. Then, the CPU 201, the ROM 202, the RAM 203, the host IF section 204, the operation unit IF section 205, the printer IF section 206, and USB-IF section 207 are mutually connected via an internal bus 208.

The controller unit 102 is connected to the host computer 101 via the host IF section 204, and is connected to the operation unit 103 via the operation unit IF section 205. The controller unit 102 is connected to the printer unit 104 via the printer IF section 206. It should be noted that the USB memory 105 is directly connected to the USB-IF section 207.

The CPU 201 loads a program stored in the ROM 202 into the RAM 203, executes it to control the entire controller unit 102. The ROM 202 stores programs and an OS that are executed by the CPU 201. The RAM 203 is not only used as a work memory to which a program is developed, but also is used as an image memory for an image data process.

The host IF section 204 may be configured so as to connect to the host computer 101 via a network such as the Ethernet (the registered trademark) etc., or may be configured so as to connect to the host computer 101 via a local connection by a USB interface etc. Then, the CPU 201 communicates with the host computer 101 via the host IF section 204 and exchanges job data (image data), a command, and status.

The operation unit IF section 205 is used to communicate with the operation unit 103. The CPU 201 exchanges a command and status with the operation unit 103 via the operation unit IF section 205. The CPU 201 sends display data to the operation unit 103. The operation unit 103 displays information corresponding to the display data onto the display unit (for example, an LCD).

The printer IF section 206 is used to communicate with the printer unit 104. The CPU 201 exchanges a command, status, and image data with the printer unit 104 via the printer IF section 206. The USB-IF section 207 is used to communicate with the USB memory 105. The CPU 201 exchanges image data, a command, and status with the USB memory 105 via the USB-IF section 207.

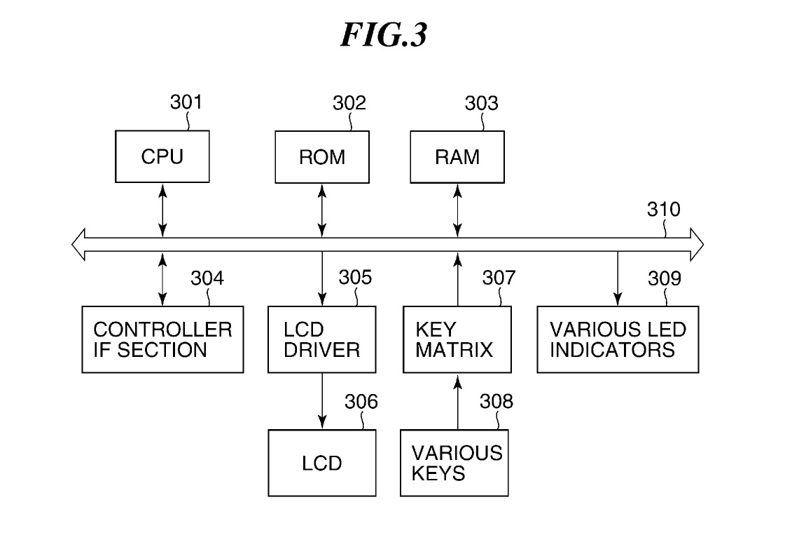

FIG. 3 is a block diagram showing details of the operation unit 103 shown in FIG. 1.

As shown in FIG. 3, the operation unit 103 has a CPU 301, a ROM 302, a RAM 303, a controller IF section 304, an LCD (a liquid crystal display) driver 305, a key matrix 307, and various LED (light emitting diode) indicators 309. The CPU 301, the ROM 302, the RAM 303, the controller IF section 304, the LCD driver 305, the key matrix 307, and the LED indicators 309 are mutually connected via an internal bus 310. Then, an LCD 306 is connected to the LCD driver 305. Various keys 308 of a keyboard, for example, are connected to the key matrix 307. It should be noted that the operation unit 103 is connected to the controller unit 102 via the controller IF section 304.

The CPU 301 loads a program stored in the ROM 302 into the RAM 303, and executes it to control the entire operation unit 103. The ROM 302 stores programs that are executed by the CPU 301. The RAM 303 is used as a work memory to which a program is developed.

The controller IF section 304 is used to communicate with the controller unit 102. The CPU 301 exchanges a command and status with the controller unit 102 via the controller IF section 304. The CPU 301 receives display data displayed on the LCD 306 from the controller unit 102 via the controller IF 304.

The CPU 301 controls the LCD driver 305 to drive the LCD 306. Then, the CPU 301 displays the display data received from the controller unit 102 onto the LCD 306 via the controller IF section 304.

The various keys 308 includes specific keys such as a cross key that moves a cursor vertically and horizontally, a numeric keypad, and an OK key. A user instructs the CPU 301 by operating the various keys. That is, when the various keys 308 are operated, instructions according to the key operations are notified to the CPU 301 via the key matrix 307.

The LED indicators 309 notify a user of the status (an error, a sheet empty, a toner empty, etc.) of the apparatus. The CPU 301 controls on/off and blinking of the LED indicators 309 according to the instructions from the controller unit 102.

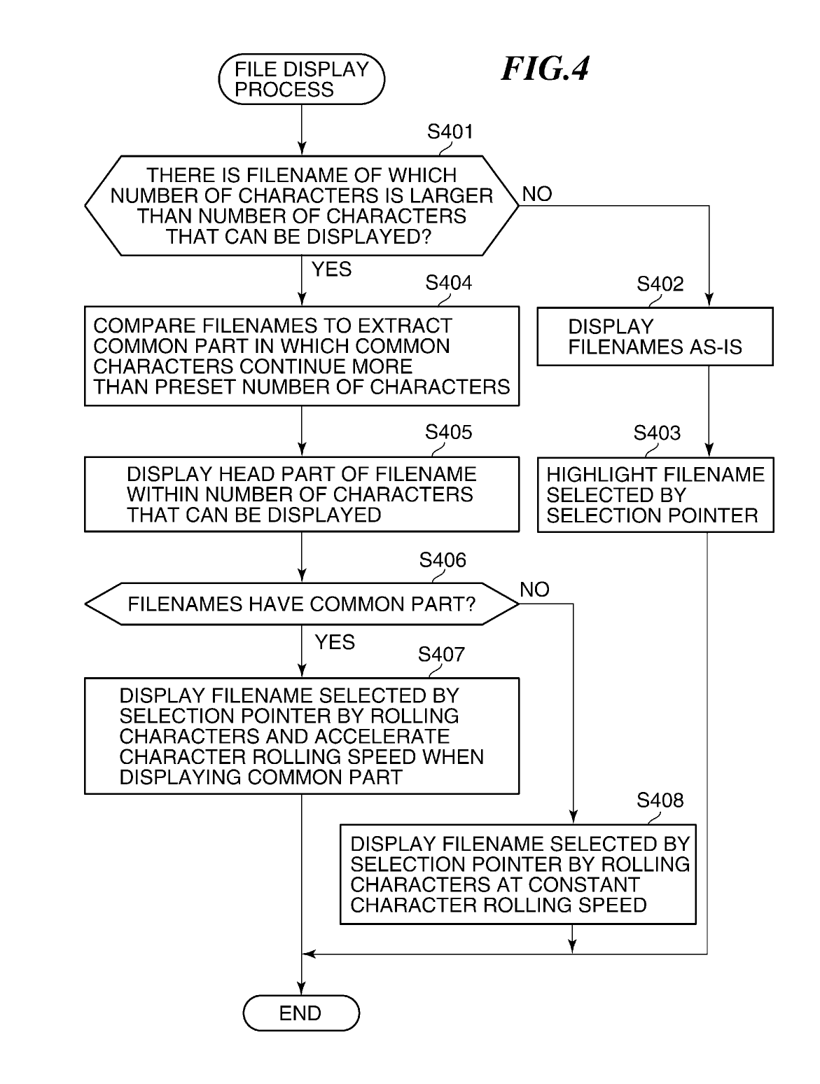

FIG. 4 is a flowchart showing a first example of a file display process in the controller unit 102 (the information display control apparatus) shown in FIG. 1.

The first example of the file display process will be described with reference to FIG. 1 through FIG. 4. When the USB memory 105 is connected (inserted) to the USB-IF section 207, the CPU 201 checks a plurality of image files stored in the USB memory 105, and starts a preparation for printing the image file concerned.

Here, the CPU 201 checks whether the number of characters of a filename of each image file is larger than the number of characters that can be displayed on the LCD 306. That is, the CPU 201 checks whether there is a filename of which the number of characters is larger than the number of characters that can be displayed (the predetermined number of characters) in step S401.

When there is no filename of which the number of characters is larger than the number of characters that can be displayed (NO in the step S401), the CPU 201 sends the filenames to the operation unit 103 via the operation unit IF section 205. In the operation unit 103, the CPU 301 controls the LCD driver 305 to display the filenames on the LCD 306. That is, the CPU 301 displays a filename list on the LCD 306 as-is (step S402). Then, when a user selects one of the listed filenames by a selection pointer, the CPU 301 highlights (inverts) the original filename onto the LCD 306 (step S403). And the CPU 301 finishes the display process.

On the other hand, when there is a filename (this is called a long filename below) of which the number of characters is larger than the number of characters that can be displayed (YES in the step S401), the CPU 201 compares the filenames to extract a common part in which common characters continue more than the preset number of characters (step S404). Here, the preset number of characters is 1, for example. Next, the CPU 201 instructs the CPU 301 to display only a head part of a long filename within the number of characters that can be displayed onto the LCD 306 (step S405).

Accordingly, the CPU 301 displays only the part of the long filename within the number of characters that can be displayed onto the LCD 306. That is, when the number of characters of the filename is larger than the predetermined number (the number of characters that can be displayed), a part of a filename will be displayed as a partially displayed filename within the number of characters that can be displayed. It should be noted that the CPU 301 displays a filename (it is called a regular-length filename below) other than a long filename onto the LCD 306 as-is.

In this case, when the selection pointer points to a long filename, the CPU 301 highlights the long filename by rolling characters. That is, when the partially displayed filename is pointed as a selected filename, the full filename of the selected filename concerned is highlighted by rolling characters in the top-to-tail direction. On the other hand, when the selection pointer points to a regular-length filename, the CPU 301 highlights the regular-length filename as-is without rolling characters. That is, the CPU 301 displays a long filename and a regular-length filename in different ways, respectively, when the selection pointer points to a filename.

Next, the CPU 201 determines whether long filenames have a common part (step S406). When determining that the long filenames have the common part (YES in the step S406), the CPU 201 instructs the CPU 301 to accelerate a character rolling speed when displaying the common part in the long filename to which the selection pointer points.

Accordingly, when displaying the common part in the long filename pointed by the selection pointer onto the LCD 306, the CPU 301 accelerates the character rolling speed (step S407). That is, when the long filename has a common part, the character rolling speed is changed.

As a result, when similar filenames are displayed onto the LCD 306, a different part (difference) is emphasized. That is, the user can check the common part in the filename quickly and can check the different part slowly, which allows to select a file smoothly.

On the other hand, when determining that the long filenames do not have the common part (NO in the step S406), the CPU 201 instructs the CPU 301 to keep the character rolling speed constant when displaying the long filename to which the selection pointer points.

Accordingly, the CPU 301 displays the long filename to which the selection pointer points onto the LCD 306 at the constant character rolling speed (step S408). That is, when there is no common part, a long filename is displayed at the constant character rolling speed.

As mentioned above, since a long filename is displayed by rolling characters, a user can check the long filename certainly even if the LCD 306 with a character number limit is used.

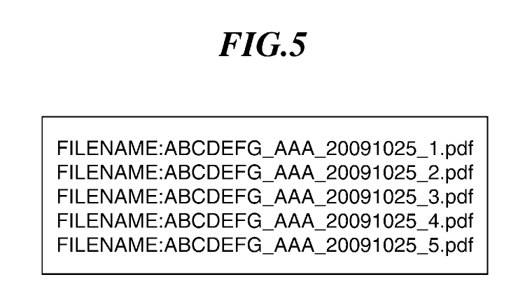

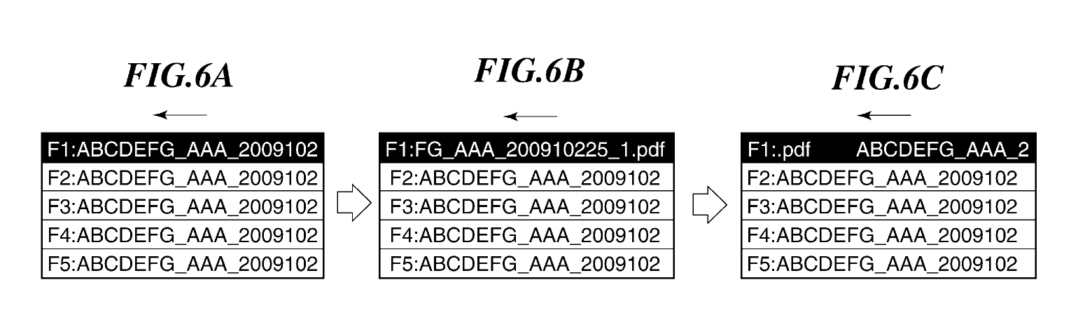

FIG. 5 is a view showing an example of a filename list displayed on the operation unit 103 shown in FIG. 1. FIG. 6A is a view showing a screen displayed on the LCD 306 shown in FIG. 3 as a result of executing the file display process shown in FIG. 4 for the filename list shown in FIG. 5. FIG. 6B is a view showing a screen where the selected filename in the screen shown in FIG. 6A is displayed by rolling characters and the character rolling speed becomes slow. FIG. 6C is a view showing a screen where the selected filename in the screen shown in FIG. 6A is displayed by rolling characters and the character rolling speed becomes fast.

The USB memory 105 shall store the filename list shown in FIG. 5. In this filename list, all the filenames are long filenames. Therefore, according to the flowchart in FIG. 4, parts of filenames within the number of characters that can be displayed onto the LCD 306 are displayed onto the LCD 306 (see FIG. 6A).

In FIG. 6A, when the selection pointer points to the filename F1, the filename F1 concerned is displayed by rolling characters in the head-to-tail direction as shown by the solid line arrow. When characters of the filename F1 that are other than the common part with the filenames F2 through F5 are displayed by rolling the characters, the character rolling speed becomes slower than regular. In the screen shown in FIG. 6B, since the part of the filename F1 that is other than the common part is displayed, the character rolling speed becomes slow (first character rolling speed).

On the other hand, in the screen shown in FIG. 6C, since the characters of the filename F1 that are common to the filenames F2 through F5 are displayed, the character rolling speed becomes fast. That is, the character rolling speed becomes second character rolling speed that is faster than the first character rolling speed.

In the illustrated example, the filename to which the selection pointer points is displayed by rolling the characters of the filename in the top-to-tail direction. The full filename is displayed repeatedly. When the numerals at the tail of the filename that are different from the similar filenames are displayed, the character rolling speed becomes slow. On the other hand, when the characters that are common to the similar filenames are displayed, the character rolling speed becomes fast.

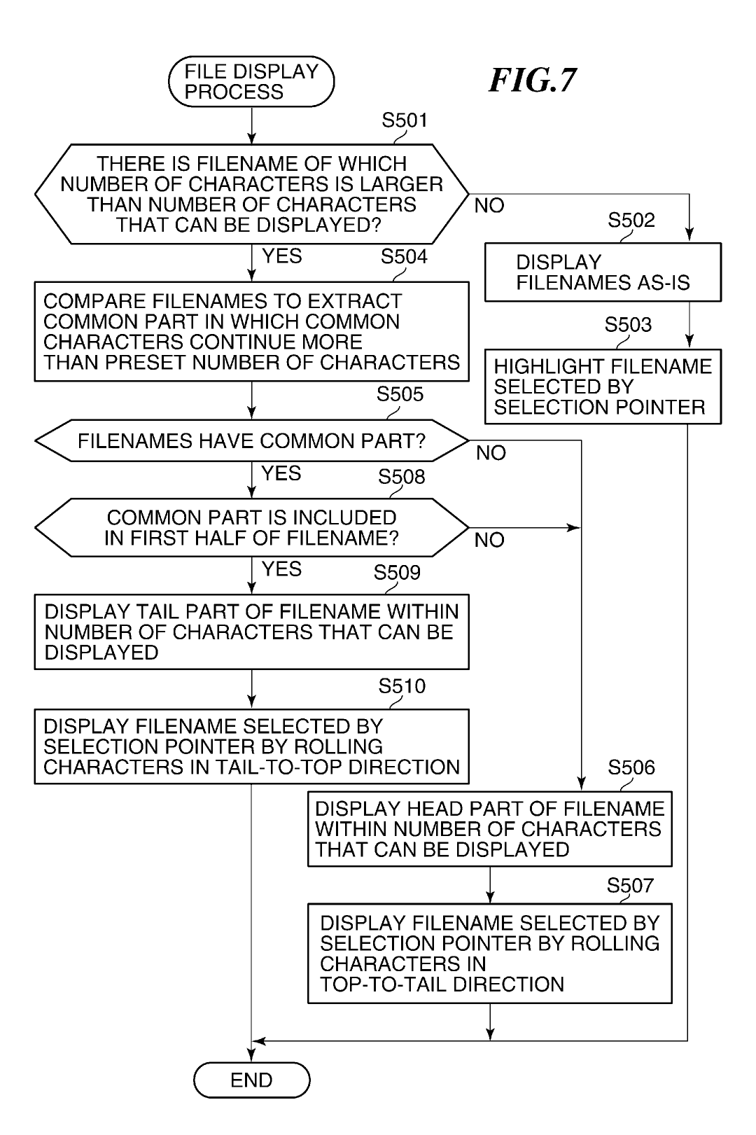

FIG. 7 is a flowchart showing a second example of the file display process in the information display control apparatus shown in FIG. 1.

The second example of the file display process will be described with reference to FIG. 1 through FIG. 3 and FIG. 7. When the USB memory 105 is connected (inserted) to the USB-IF section 207, the CPU 201 checks image files stored in the USB memory 105 in order to determine whether there is a filename of which the number of characters is larger than the number of characters that can be displayed onto the LCD 306 (step S501).

When there is no filename of which the number of characters is larger than the number of characters that can be displayed (NO in the step S501), the CPU 201 sends the filenames to the operation unit 103 via the operation unit IF section 205. That is, the CPU 301 displays a filename list on the LCD 306 as-is (step S502). Then, when a user selects one of the listed filenames by the selection pointer, the CPU 301 highlights (inverts) the original filename onto the LCD 306 (step S403). Then, the CPU 301 finishes the display process.

On the other hand, when there is a filename of which the number of characters is larger than the number of characters that can be displayed (YES in the step S501), the CPU 201 compares the filenames to extract a common part in which common characters continue more than the preset number of characters (step S504).

Next, the CPU 201 determines whether long filenames have a common part (step S505). When there is no common part (NO in the step S505), the CPU 201 instructs the CPU 301 to display a head part of the long filename within the number of characters that can be displayed onto the LCD 306 (step S506).

Accordingly, the CPU 301 displays only the head part of the long filename within the number of characters that can be displayed onto the LCD 306. It should be noted that the CPU 301 displays a regular-length filename onto the LCD 306 as-is.

In this case, when the selection pointer points to a long filename, the CPU 301 highlights the long filename by rolling characters. Here, the CPU 301 displays a long filename by rolling characters in the top-to-tail direction (step S507). On the other hand, when the selection pointer points to a regular-length filename, the CPU 301 highlights the regular-length filename as-is without rolling characters.

When the long filename has a common part (YES in the step S505), the CPU 201 determines whether the common part is included in a first half of the long filename (step S508). When the common part is not included in the first half (NO in the step S508), the CPU 101 proceeds with the process to the step S506 and continues the process.

On the other hand, when the common part is included in the first half of the long filename (YES in the step S508), the CPU 201 instructs the CPU 301 to display a tail part of the long filename within the number of characters that can be displayed onto the LCD 306 (step S509).

Accordingly, the CPU 301 displays only the tail part of the long filename within the number of characters that can be displayed onto the LCD 306. It should be noted that the CPU 301 displays a regular-length filename onto the LCD 306 as-is as described above.

In this case, when the selection pointer points to a long filename, the CPU 301 highlights the long filename by rolling characters. Here, the CPU 301 displays the long filename by rolling characters in the tail-to-top direction (step S510). On the other hand, when the selection pointer points to a regular-length filename, the CPU 301 highlights the regular-length filename as-is without rolling characters.

Thus, when there are similar filenames, the user can check a different part (difference) on the first screen. Then, when the selection pointer points to the filename concerned, the filename is displayed by rolling characters and the user can check the full filename. As a result, the user can check the long filename certainly even if the LCD 306 with a character number limit is used.

It should be noted that the CPU 301 may decrease the character rolling speed when displaying the different characters in the same manner as the example shown in FIG. 4.

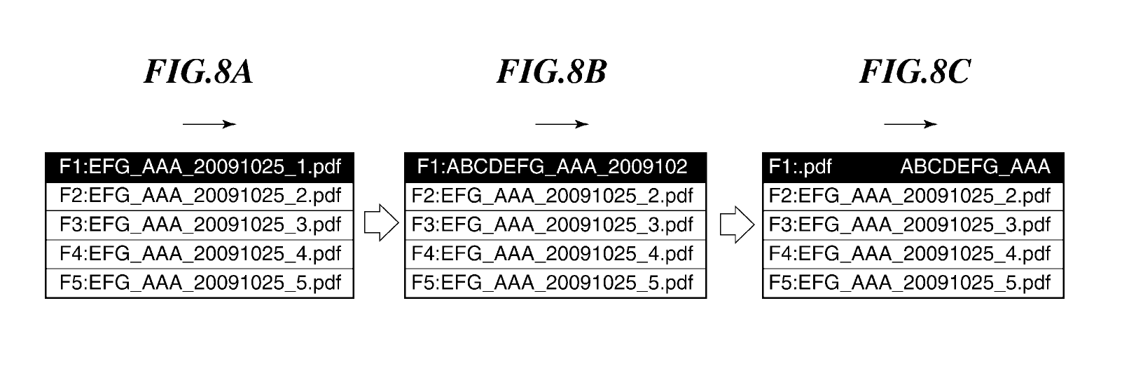

FIG. 8A is a view showing a screen displayed on the LCD 306 shown in FIG. 3 as a result of executing the file display process shown in FIG. 7 for the filename list shown in FIG. 5. FIG. 8B is a view showing a screen displaying a common part in the selected filename among the filenames in the screen shown in FIG. 8A. FIG. 8C is a view showing a screen displaying a different part in the selected filename among the filenames in the screen shown in FIG. 8A.

According to the flowchart in FIG. 7, parts of filenames within the number of characters that can be displayed onto the LCD 306 are displayed onto the LCD 306 (see FIG. 8A). In the example in FIG. 5, since the common part in the filenames is included in the first half, the tail parts of the filenames are displayed. In FIG. 8A, when the selection pointer points to the filename F1, the filename F1 concerned is displayed by rolling characters in the direction as shown by the solid line arrow. In this case, since each of the filenames F1 through F5 has the different part in the second half of a filename, the filename is displayed by rolling characters in the tail-to-top direction.

In the illustrated example, when the characters of the filename F1 that are different from the filenames F2 through F5 are displayed by rolling the characters, the character rolling speed becomes slower than regular. Since the common part in the filename F1 is displayed in the screen shown in FIG. 8B, the character rolling speed becomes fast.

On the other hand, in the screen shown in FIG. 8C, since the characters of the filename F1 that are different from the filenames F2 through F5 are displayed, the character rolling speed becomes slow.

In the illustrated example, the filename F1 to which the selection pointer points is displayed by rolling the characters of the filename in the tail-to-top direction. The full filename is displayed repeatedly. When the numerals at the tail of filename that are different from the similar filenames are displayed, the character rolling speed becomes slow. On the other hand, when the characters that are common to the similar filenames are displayed, the character rolling speed becomes fast.

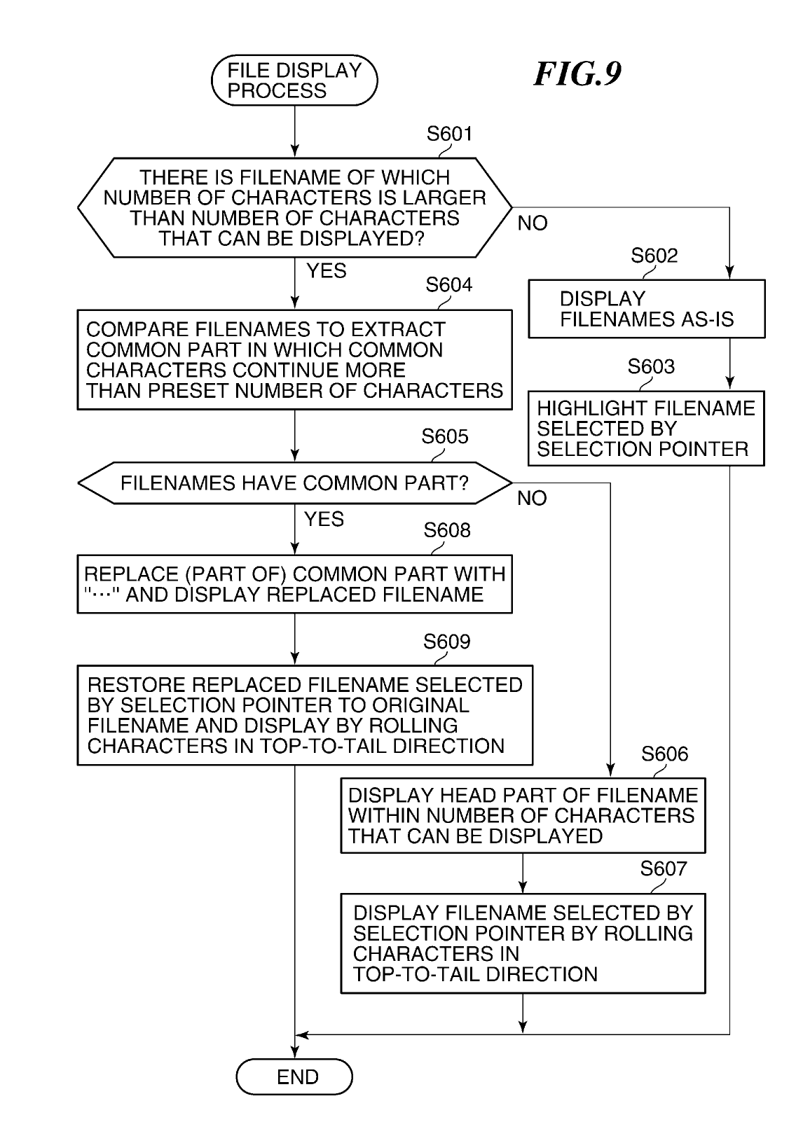

FIG. 9 is a flowchart showing a third example of the file display process in the information display control apparatus shown in FIG. 1.

The third example of the file display process will be described with reference to FIG. 1 through FIG. 3 and FIG. 9. When the USB memory 105 is connected to the USB-IF section 207, the CPU 201 checks image files stored in the USB memory 105 in order to determine whether there is a filename given to each of the image file of which the number of characters is larger than the number of characters that can be displayed (step S601).

When there is no filename of which the number of characters is larger than the number of characters that can be displayed (NO in the step S601), the CPU 201 sends the filenames to the operation unit 103 via the operation unit IF section 205. In the operation unit 103, the CPU 301 displays the filenames on the LCD 306 as-is (step S602). Then, when a user selects one of the listed filenames by the selection pointer, the CPU 301 highlights (inverts) the original filename onto the LCD 306 (step S603). Then, the CPU 301 finishes the display process.

On the other hand, when there is a filename of which the number of characters is larger than the number of characters that can be displayed (YES in the step S601), the CPU 201 compares the filenames to extract a common part in which common characters continue more than the preset number of characters (step S604).

Next, the CPU 201 determines whether long filenames have a common part (step S605). When there is no common part (NO in the step S605), the CPU 201 instructs the CPU 301 to display a head part of the long filename within the number of characters that can be displayed onto the LCD 306 (step S606).

Accordingly, the CPU 301 displays only the head part of the long filename within the number of characters that can be displayed onto the LCD 306. It should be noted that the CPU 301 displays a regular-length filename onto the LCD 306 as-is.

In this case, when the selection pointer points to a long filename, the CPU 301 displays the long filename by rolling characters onto the screen. When displaying a filename by rolling characters, the CPU 301 displays the long filename by rolling characters in the top-to-tail direction (step S607).

When the long filename has a common part (YES in the step S605), the CPU 201 replaces at least a part of the common part with a predetermined symbol (for example, “ . . . ”), and sends the replaced filename and the original filename to the operation unit 103. Then, the CPU 301 displays the replaced filename onto the LCD 306 (step S608). In this case, the number of characters of the replaced filename is equal to or smaller than the number of characters that can be displayed.

When the selection pointer points to the replaced filename, the CPU 301 restores the replaced filename to the original filename, and displays the original filename onto the LCD 306 by rolling characters (step S609). In this case, the CPU 301 displays a long filename by rolling characters in the top-to-tail direction, for example.

The replaced filenames are displayed onto the LCD 306 with a character number limit. And when the selection pointer points to the replaced filename, the original filename is displayed by rolling the characters. Accordingly, when a user selects the filename while checking a different part, the user can check the full filename.

It should be noted that the CPU 301 may decrease the character rolling speed when displaying the different part.

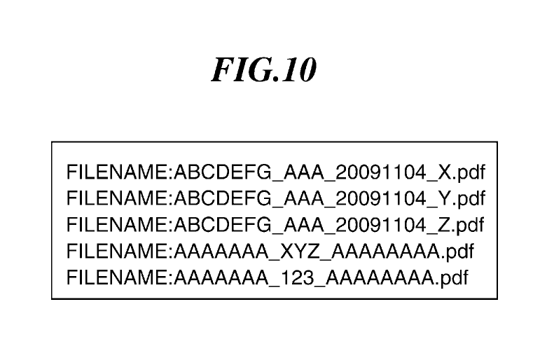

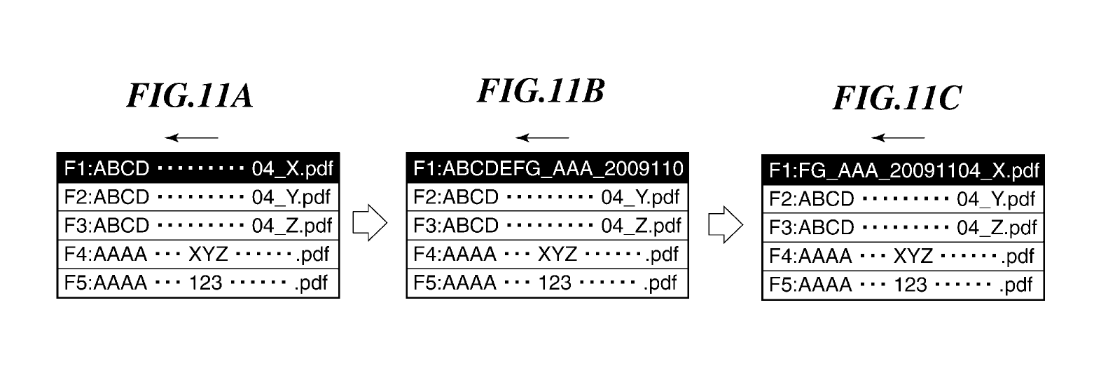

FIG. 10 is a view showing another example of the filename list displayed on the operation unit 103 shown in FIG. 1. FIG. 11A is a view showing a screen displayed on the LCD 306 shown in FIG. 3 as a result of executing the file display process shown in FIG. 9 for the filename list shown in FIG. 10. FIG. 11B is a view showing a screen displaying a common part in the selected filename among the filenames in the screen shown in FIG. 11A. FIG. 11C is a view showing a screen displaying a different part in the selected filename among the filenames in the screen shown in FIG. 11A.

The USB memory 105 shall store the filename list shown in FIG. 10. In this filename list, all the filenames are long filenames that have a common part. Therefore, according to the flowchart in FIG. 9, replaced filenames are displayed onto the LCD 306 (see FIG. 11A). That is, the common part is replaced with the symbol “ . . . ”, and is displayed.

In FIG. 11A, when the selection pointer points to the replaced filename F1, the CPU 301 restores the filename concerned to the original filename, and display by rolling characters (see FIG. 11B). In this case, the original filename F1 is displayed by rolling the characters in the top-to-tail direction as shown by the solid line arrow.

In the illustrated example, when the characters of the filename F1 that are common to the filenames F2 through F5 are displayed by rolling the characters, the character rolling speed becomes fast. Since the common part in the filename F1 is displayed in the screen shown in FIG. 11B, the character rolling speed becomes fast.

On the other hand, in the screen shown in FIG. 11C, since the characters of the filename F1 that are different from the filenames F2 through F5 are displayed, the character rolling speed becomes slow.

In the illustrated example, the full original filename F1 to which the selection pointer points is displayed repeatedly. When the numerals at the tail of filename that are different from the similar filenames are displayed, the character rolling speed becomes slow. On the other hand, when the characters that are common to the similar filenames are displayed, the character rolling speed becomes fast.

In the example shown in FIG. 10, the upper three filenames are mutually similar, and the lower two filenames are mutually similar. In the third example, since at least a part of the common part of the filenames shown in FIG. 10 is replaced with the symbol “ . . . ” to form the replaced filenames, the different parts among the similar filenames are emphasized.

In the example shown in FIG. 10, the upper three filenames have the different parts at their tails. The lower two filenames have the different parts around their centers.

Therefore, in the illustrated example, the middle parts of the upper three filenames are replaced with the symbol “ . . . ”, and the middle and tail parts of the lower two filenames except the different parts are replaced with the symbol “ . . . ”.

Then, as mentioned above, since the selection pointer points to the replaced filename F1, the CPU 301 restores the filename concerned to the original filename, and display by rolling the characters in the top-to-tail direction.

The full filename is displayed repeatedly. When the numerals at the tail of the filename that are different from the similar filenames are displayed, the character rolling speed becomes slow. When the different part is included in the first half of the filename, the direction for rolling characters may be changed to the tail-to-top direction.

Although the embodiments of the invention have been described, the present invention is not limited to the above-mentioned embodiment, the present invention includes various modifications as long as the concept of the invention is not deviated.

For example, an information display control method that corresponds to the function of the above-mentioned embodiment may be performed by the information display control apparatus. Moreover, a computer with which the information display control apparatus is provided may execute an information display control program that has the functions of the above-mentioned embodiment. In these cases, each of the information display control method and the information display control program includes at least a first determination step, a second determination step, a first display control step, and a second display control step.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-173627, filed on Aug. 2, 2010, which is hereby incorporated by reference herein in its entirety.

What is claimed is:

1. An information display control apparatus that displays a plurality of filenames onto a display unit for allowing a user to select, comprising:
a first determination unit configured to determine whether the number of characters of each filename is larger than the predetermined number of characters;
a second determination unit configured to compare the filenames to determine whether the filenames have a common part in which common characters continue more than the preset number of characters; and
a display control unit configured to display a part of the filename as a partially displayed filename onto the display unit within the predetermined number of characters and to display the full filename onto the display unit by rolling characters when said first determination unit determines that the number of characters of the filename is larger than the predetermined number of characters,
wherein said display control unit changes character rolling speed according to a determination result by said second determination unit when the filename is displayed by rolling characters.

2. The information display control apparatus according to claim 1, wherein said display control unit decreases the character rolling speed when displaying a different part that is other than the common part given by the determination result by said second determination unit compared with when displaying the common part.

3. The information display control apparatus according to claim 1, further comprising a third determination unit configured to determine whether the common part is included in the first half of the filename,
wherein said display control unit changes the direction of rolling characters according to a determination result by said third determination unit.

4. The information display control apparatus according to claim 3, wherein said display control unit displays a head part of the filename within the predetermined number of characters as the partially displayed filename and displays the full filename by rolling characters in the top-to-tail direction of the filename when said third determination unit determines that the common part is not included in the first half of the filename.

5. The information display control apparatus according to claim 3, wherein said display control unit displays a tail part of the filename within the predetermined number of characters as the partially displayed filename and displays the full filename by rolling characters in the tail-to-top direction of the filename when said third determination unit determines that the common part is included in the first half of the filename.

6. The information display control apparatus according to claim 1, wherein said display control unit replaces at least a part of the common part with a predetermined symbol and displays the replaced filename onto the display unit when said first determination unit determines that the number of characters of the filename is larger than the predetermined number of characters.

7. The information display control apparatus according to claim 6, wherein said display control unit displays the original filename corresponding to the replaced filename that is selected by a user by rolling characters.

8. An information display control apparatus that displays a plurality of filenames onto a display unit for allowing a user to select, comprising:
a first determination unit configured to determine whether the number of characters of each filename is larger than the predetermined number of characters;
a second determination unit configured to compare the filenames to determine whether the filenames have a common part in which common characters continue more than the preset number of characters; and
a display control unit configured to replace at least a part of the common part with a predetermined symbol and to display the replaced filename onto the display unit when said first determination unit determines that the number of characters of the filename is larger than the predetermined number of characters and when said second determination unit determines that there is the common part.

9. An information display control method for displaying a plurality of filenames onto a display unit for allowing a user to select, comprising:
a first determination step of determining whether the number of characters of each filename is larger than the predetermined number of characters;
a second determination step of comparing the filenames to determine whether the filenames have a common part in which common characters continue more than the preset number of characters;
a first display control step of displaying a part of the filename as a partially displayed filename onto the display unit within the predetermined number of characters when it is determined that the number of characters of the filename is larger than the predetermined number of characters in said first determination step, and of displaying the full filename of a selected filename onto the display unit by rolling characters when the partially displayed filename is pointed as the selected filename; and
a second display control step of changing character rolling speed according to the determination result in said second determination step when displaying the selected filename by rolling characters.

10. An information display control method for displaying a plurality of filenames onto a display unit for allowing a user to select, comprising:
a first determination step of determining whether the number of characters of each filename is larger than the predetermined number of characters;
a second determination step of comparing the filenames to determine whether the filenames have a common part in which common characters continue more than the preset number of characters;
a display control step of replacing at least a part of the common part with a predetermined symbol and of displaying the replaced filename onto the display unit when it is determined that the number of characters of the filename is larger than the predetermined number of characters in said first determination step and when it is determined that there is the common part in said second determination step.

11. A non-transitory computer-readable storage medium storing an information display control program causing a computer to execute an information display control method for displaying a plurality of filenames onto a display unit for allowing a user to select, the information display control method comprising:
a first determination step of determining whether the number of characters of each filename is larger than the predetermined number of characters;
a second determination step of comparing the filenames to determine whether the filenames have a common part in which common characters continue more than the preset number of characters;
a first display control step of displaying a part of the filename as a partially displayed filename onto the display unit within the predetermined number of characters when it is determined that the number of characters of the filename is larger than the predetermined number of characters in said first determination step, and of displaying the full filename of a selected filename onto the display unit by rolling characters when the partially displayed filename is pointed as the selected filename; and
a second display control step of changing character rolling speed according to the determination result in said second determination step when displaying the selected filename by rolling characters.

12. A non-transitory computer-readable storage medium storing an information display control program causing a computer to execute an information display control method for displaying a plurality of filenames onto a display unit for allowing a user to select, the information display control method comprising:
a first determination step of determining whether the number of characters of each filename is larger than the predetermined number of characters;
a second determination step of comparing the filenames to determine whether the filenames have a common part in which common characters continue more than the preset number of characters;
a display control step of replacing at least a part of the common part with a predetermined symbol and of displaying the replaced filename onto the display unit when it is determined that the number of characters of the filename is larger than the predetermined number of characters in said first determination step and when it is determined that there is the common part in said second determination step.
